(19) United States
(12) Patent Application Publication
(10) Pub. No.: US 2017/0191609 A1
(43) Pub. Date: Jul. 6, 2017

(54) Rail Post Vertical Extension System

(71) Applicant: Ryan Zoutman, Drumheller (CA)

(72) Inventor: Ryan Zoutman, Drumheller (CA)

(21) Appl. No.: 14/985,409

(22) Filed: Dec. 31, 2015

(51) Int. Cl. F16M 13/02; A01K 39/01; F21V 21/108; E04H 15/54; G09F 17/00; A01G 9/12; A01K 5/00

(52) U.S. Cl. CPC F16M 13/02; A01G 9/12; A01K 39/01; A01K 5/00; E04H 15/54; G09F 17/00; F21V 21/108

(57) ABSTRACT

A rail post vertical extension systems for a deck, patio boundary or fence rail posts to alter the appearance of the posts by suspending plants in a decorative and structurally sturdy manner. Rail post vertical extension system may have a base support end, a rod, and at least one arm receiver. The base support end may include a male insert that may be removably inserted into the female receiver of a rail post, and a flange end to aid in retaining the base support end into the rail post. A rod is attached to the base support end and has a length that is structured and arranged to support the attachment of at least one arm receiver.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of rail mounted ornamental plant hangers and more specifically relates to a rail post vertical extension system.

2. Description of Related Art

Patio and deck railings and even fence railings are functional installations intended to define the boundaries of an entertainment area or land limit. As functional installations, in addition to providing definition, they may also perform supporting functions such as providing strength for the railing structure. In general terms, patio, deck, and fence railing aesthetics are simple and may be void of decoration. To enhance the appearance of railing installations, items such as flag poles and planters are often added-on afterward to provide some visual interest and customization. These add-ons can appear to be haphazardly placed and may differ in appearance from the railings because they are made by companies other than the rail manufacturer. They also may have characteristics such as support members that may extend to, and are secured into, the deck or patio floor surface, which may inadvertently introduce tripping hazards in to the space. Rail add-ons attempt to tap into the structural strength of the rail installations but are not integrated in to the overall structure and, therefore, are subject to misalignment and installation failure. An aesthetic and safe solution is desirable.

Several attempts have been made to solve the above-mentioned problems such as those found in U.S. Pub. Nos. 2003/0173474 to Taylor; 2007/0101645 to Christopher et al; 2010/0243975 to Stover; 2012/0144654 to Christian et. al., U.S. Pat. No. 4,991,344 to Carney; U.S. Pat. No. 5,487,476 to Barfield; U.S. Pat. No. 5,873,195 to Wortham; U.S. Pat. No. 5,934,014 to Carrothers; U.S. Pat. No. 6,520,665 to Scandle; U.S. Pat. No. 6,557,806 to Davies; U.S. Pat. No. 7,740,216 to Puckett et. al.; and U.S. Pat. No. 8,955,808 to Buschbach. This art is representative of rail mounted ornamental plant hangers. However, none of the above inventions and patents, taken either singly or in combination, is seen to describe the invention as claimed.

Preferably, a rail mounted ornamental plant hanger should provide a structurally sturdy assembly to hang plants from a deck or fence rail and, yet would operate reliably and be manufactured at a modest expense. Thus, a need exists for a reliable rail post vertical extension system to avoid the above-mentioned problems.

### BRIEF SUMMARY OF THE INVENTION

In view of the foregoing disadvantages inherent in the known rail mounted ornamental plant hanger art, the present invention provides a novel rail post vertical extension system. The general purpose of the present invention, which will be described subsequently in greater detail is to provide a structurally sturdy assembly to hang plants from a deck or fence rail in an aesthetically pleasing manner.

Rail post vertical extension systems is disclosed herein in a preferred embodiment comprising a base support end, a rod, and at least one arm receiver (preferably) comprising a ferrous material. The base support end may comprise a male insert that may be removably inserted into a female receiver of a rail post, and a flange end to aid in retaining the base support end into a rail post. A rod is attached to the base support end and has a length structured and arranged to support the attachment of at least one arm receiver. The at least one arm receiver has a horizontal length and a gusset, with the gusset structured and arranged to reduce (distribute) load stress, thus effectively increasing the load bearing capability of the at least one arm receiver. The at least one arm receiver may support at least one retainable object such as a plant holder, wind screen, bug screen, sun shade, animal feeder, light, or a flag. Other items may be supported as per application.

The rail post extension system may be inserted and removed with minimal effort. A plurality of items may be interchangeably hung on the arm receiver. In other embodiments of the present invention, a plurality of utility items may replace the arm receiver. Items such as beverage ice buckets, shelves to hold lamps or decorative items, racks to hold or arrange barbeque accessories, or music and television speaker systems may be affixed to the base support end. The present invention is for use in hanging or otherwise supporting a host of items and accessories. The items listed are examples and do not limit the scope of the invention in any way, but simply provide exemplary means for carrying out use of the present invention. The rail post extension system may be ideal for anyone who has a deck or fence rail post and would like to alter the appearance of the deck boundary or fence by suspending plants in a decorative and structurally sturdy manner Some of the newer post/railing designs have 4 holed sections in the corners and the present invention as such may comprise an insert design to accommodate this structure.

The present invention holds significant improvements and serves as a structurally sturdy assembly to hang plants from a deck or fence rail. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, rail post vertical extension system, constructed and operative according to the teachings of the present invention.

FIG. 1 shows a perspective view illustrating a rail post vertical extension system during an ‘in-use’ condition showing a rail post vertical extension according to an embodiment of the present invention.

FIG. 2 is a perspective view illustrating the rail post vertical extension system comprising a rail post vertical extension according to an embodiment of the present invention of FIG. 1.

FIG. 3 is an exploded perspective view illustrating the rail post vertical extension system according to an embodiment of the present invention of FIGS. 1-2.

FIG. 4 is a perspective view illustrating the rail post vertical extension system according to an alternative use of the present invention of FIGS. 1-3.

FIG. 5 is a flowchart illustrating a method of use for the rail post vertical extension system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a rail mounted ornamental plant hangers and more particularly to a rail post vertical extension system as used to improve a structurally sturdy assembly to hang plants from a deck or fence rail.

Generally speaking, rail post vertical extension system may resemble a base support end, a rod, and at least one arm receiver, as previously mentioned. The rail post vertical extension may be removably inserted in a deck or fence rail by anyone who has a deck or fence rail post and would like to alter the appearance of the deck boundary or fence by inserting the male insert of the base support end in the such that at least one arm receiver is elevated for supporting at least one retainable object. The at least one arm receiver may support at least one retainable object such as a plant holder, wind screen, bug screen, sun shade, animal feeder, light, a flag, or the like. The rail post extension system may be inserted and removed with little effort. The rail post extension system may alter the appearance of the deck boundary or fence by suspending plants in a decorative and structurally sturdy manner.

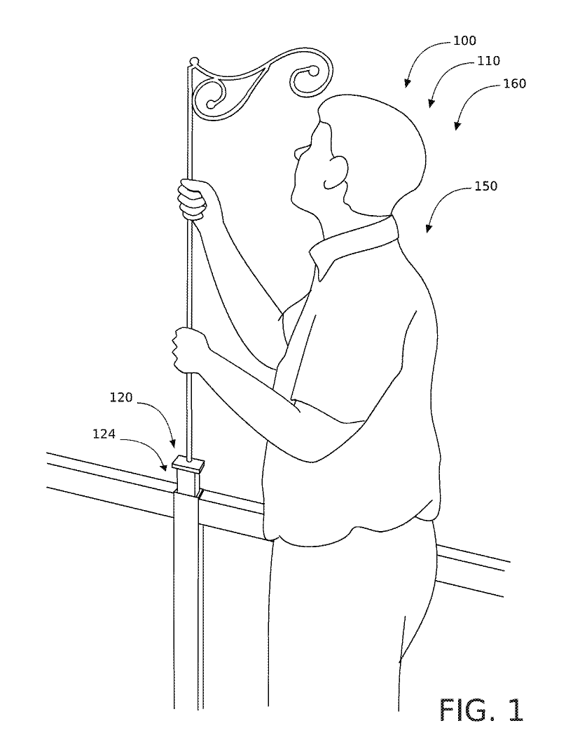

Referring to the drawings by numerals of reference there is shown in FIG. 1, a perspective view illustrating a rail post vertical extension system 100 during an ‘in-use’ condition 160 showing rail post vertical extension 110 wherein user 150 may removably insert male insert 124 of base support end 120 into top of female receiver of rail post according to an embodiment of the present invention.

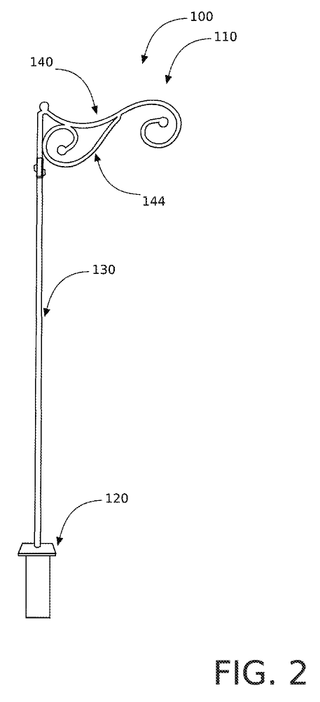

Referring now to FIG. 2, a perspective view illustrating rail post vertical extension system 100 comprising rail post vertical extension 110 according to an embodiment of the present invention. Rail post vertical extension comprises 110 in structural combination base support end 120, rod 130, at least one arm receiver 140 to receive at least one retainable object and gusset member 144 for reducing load stress increasing load bearing capability of objects. Additional arm receiver configurations may be used in alternate embodiments of the present invention.

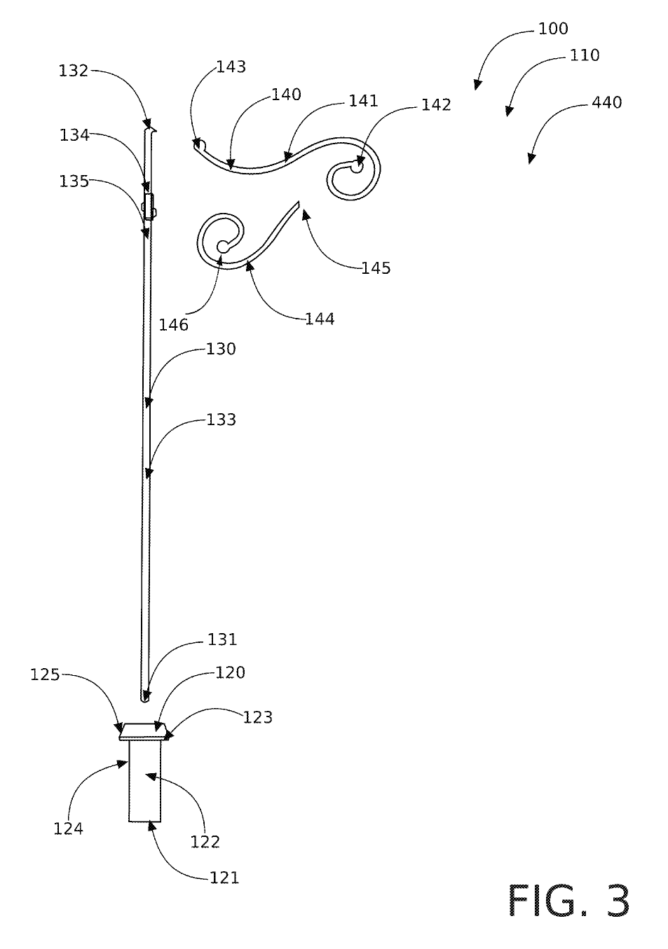

Referring now to FIG. 3, an exloded view illustrating rail post vertical extension system 100 which may comprise rail post vertical extension 110 comprising base support end 120 having primary-end 121, vertical section 122, and secondary-end 123. Base support end 120 is removably insertable into square tubing posts, deck rails or fence rails. Further, base support end 120 primary-end 121 may comprise male insert 124 and flange 125 comprising secondary-end 123. Primary-end 121 is integrally connected to secondary-end 123 via vertical section 122. Rail post vertical extension 110 may further comprise rod 130 comprising bottom-end 131, top-end 132, length 133 mid-point 135, and upper segment 134. Bottom-end 131 of rod 130 is integrally joined to flange 125 of base support end 120, and bottom-end 131 is integrally connected to top-end 132 via length 133.

In continuing to refer to FIG. 3, showing at least one arm receiver 140 comprising horizontal arm length 141 distal-end 142 proximal-end 143 and at least one gusseted member 144 comprising first-end 145 and second-end 146. Further, proximal-end 143 of at least one arm receiver 140 is fixedly joined to top-end 132 of rod 130, and at least one gusseted member 144 is fixedly joined to upper-segment 134 of length 133 of rod 130 below top-end 132 and mid-point 135 of horizontal arm length 141.

Referring further to FIG. 3, showing rail post vertical extension system 100. Rail post vertical extension system 100 may be sold as kit 440 comprising the following parts: a plurality of rail post vertical extensions 110; and at least one set of user instructions. The kit has instructions such that functional relationships are detailed in relation to the structure of the invention (such that the invention can be used, maintained, or the like in a preferred manner). Rail post vertical extension system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

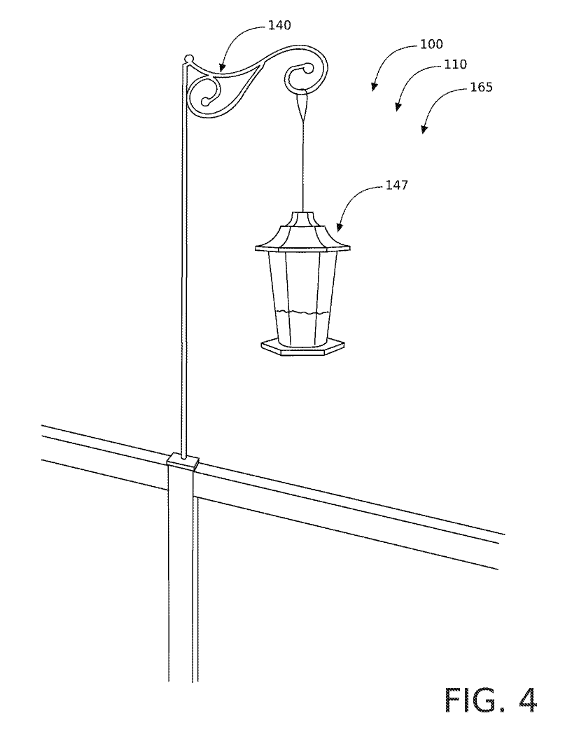

Referring now to FIG. 4, a perspective view illustrating rail post vertical extension system 100 preferably comprising rail post vertical extension 110 according to an alternative use of the present invention wherein at least one arm receiver 140 comprises at least one retainable object comprises animal feeder 147.

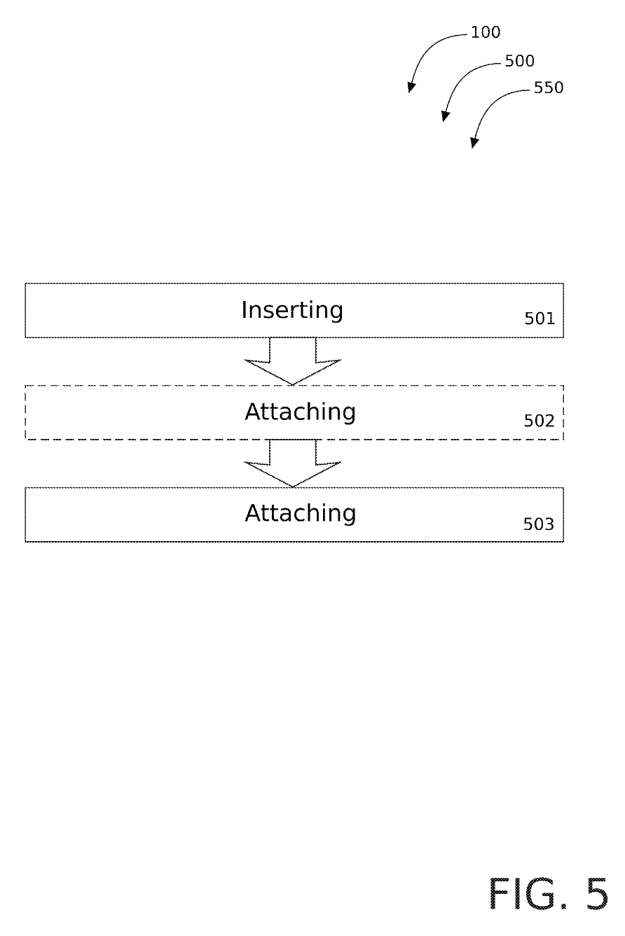

Referring now to FIG. 5 showing flowchart 550 illustrating method of use 500 for rail post vertical extension system 100 according to an embodiment of the present invention of FIGS. 1-4. As shown, method of use 500 may comprise the steps of: step one 501, inserting base support end 120, step two 502, attaching hook receivers, and step three 503, attaching arm receivers 140.

It should be noted that step 502 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A rail post vertical extension system comprising:
a base support end having a primary-end, a vertical section, and a secondary-end, said base support end comprising;
a male insert; and
a flange;
a rod comprising;
a bottom-end;
a top-end; and
a length; and
at least one arm receiver comprising;
a horizontal arm length;
a distal-end;
a proximal-end; and
at least one gusseted member;
wherein said rail post vertical extension system comprises in structural combination said base support end, said rod, and said at least one arm receiver;
wherein said primary-end comprises said male insert;
wherein said male insert is removably insertable into a female receiver of a rail post;
wherein said bottom-end of said rod is integrally joined to said flange of said base support end;
wherein said proximal-end of said at least one arm receiver is fixedly joined to said top-end of said rod;
wherein said at least one gusseted member comprises a first-end and a second-end;
wherein said first-end of said at least one gusseted member is fixedly joined to a mid-point of said horizontal arm length; and
wherein said second-end of said at least one gusseted member is fixedly joined to an upper-segment of said length of said rod below said top-end.

2. The rail post vertical extension of claim 1 wherein said base support end is removably insertable into a top of square tubing posts.

3. The rail post vertical extension of claim 1 wherein said base support end is removably insertable into deck rails.

4. The rail post vertical extension of claim 1 wherein said base support end is removably insertable into fence rails.

5. The at least one arm receiver of claim 1 wherein said at least one retainable object comprises plant holders.

6. The at least one arm receiver of claim 1 wherein said at least one retainable object comprises wind screen.

7. The at least one arm receiver of claim 1 wherein said at least one retainable object comprises bug screen.

8. The at least one arm receiver of claim 1 wherein said at least one retainable object comprises sun shade.

9. The at least one arm receiver of claim 1 wherein said at least one retainable object comprises animal feeders.

10. The at least one arm receiver of claim 1 wherein said at least one retainable object comprises illumination means.

11. The at least one arm receiver of claim 1 wherein said at least one retainable object comprises flags.

12. The rail post vertical extension of claim 1 wherein said at least one arm receiver comprises hook receivers useful for providing additional object retaining points.

13. The at least on arm receiver of claim 1 wherein said gusseted member is useful for reducing load stress increasing load bearing capability of objects.

14. The rail post vertical extension of claim 1 wherein said at least one arm receiver comprises a plurality of lengths useful for providing additional object retaining points.

15. The base support end of claim 1 wherein said male insert comprises a plurality of lengths useful for increasing load-bearing capability of objects.

16. The rail post vertical extension system of claim 1 wherein said rod comprises a square-shaped shaft.

17. A rail post vertical extension comprising:
a base support comprising ferrous material, said base support comprising a primary-end,
a vertical section, and a secondary-end, said base support end comprising;
a male insert comprising a 3D rectangular box shape; and
a flange comprising an external rim useful for strength;
a rod comprising;
a bottom-end;
a top-end; and
a length; and
at least one arm receiver comprising;
a horizontal arm length further comprising;
a distal-end;
a proximal-end; and
at least one gusseted member wherein said at least one gusseted member comprises attachment points for said at least one arm receiver and said rod;
wherein said rail post vertical extension comprises in structural combination said base support end, said rod, and said at least one arm receiver;
wherein said primary-end comprises said male insert;
wherein said male insert is structured and arranged to be removably insertable into a female receiver;
wherein said bottom-end of said rod is integrally joined to said flange of said base support end;
wherein said flange comprises said secondary-end;
wherein said bottom-end of said rod is integrally joined to said flange of said base support end;
wherein said proximal-end of said at least one arm receiver is fixedly joined to said top-end of said rod;
wherein said at least one arm receiver is defined by said horizontal arm length having said distal-end and said proximal-end;
wherein said at least one gusseted member comprises a first-end and a second-end;
wherein said first-end of said at least one gusseted member is fixedly joined to a mid-point of said horizontal arm length; and
wherein said second-end of said at least one gusseted member is fixedly joined to an upper-segment of said length of said rod below said top-end.

18. The rail post vertical extension system of claim 17 further comprising a kit including:
a plurality of said rail post vertical extensions; and
a set of user-installation instructions.

19. A method of using a rail post vertical extension system comprising the steps of:
inserting a base support end of a rail post vertical extension;
attaching hook receivers; and
attaching arm receivers.

20. The method of claim 19 further comprising the steps of removing said rail post vertical extension as desired.
